(19) United States
(12) Patent Application Publication
(10) Pub. No.: US 2006/0080258 A1
(43) Pub. Date: Apr. 13, 2006

(54) Method and system for distribution of digital downloads

(76) Inventor: Dean Vegas Christal, Santa Barbara, CA (US)

Correspondence Address: Barber Legal, P.O. Box 16220, Golden, CO, 80402-6004, US

(21) Appl. No.: 10/978,498

(22) Filed: Nov. 1, 2004

Related U.S. Application Data
(63) Continuation-in-part of application No. 10/963,917, filed on Oct. 12, 2004.

(51) Int. Cl. G06Q 99/00

(52) U.S. Cl. 705/51

(57) ABSTRACT

A method and system for promoting digital file downloads by placing download terminals at commercial establishments which prepossess a high volume of customer traffic. The point-of-sale (POS) station (cash register) of the commercial establishment sells an access code which the user then enters via a scanner or a keypad of the download terminal in order to receive a digital file download. The access code may identify the digital file to download, or the user may identify the file to download. The digital files downloaded may by MP3 files, music files, video files, data files, book files, game files and combinations thereof. The invention includes an output device allowing the user to attach a player to accept the downloaded file.

### CROSS-REFERENCE TO RELATED APPLICATIONS

This application claims the priority and benefit of U.S. application Ser. No. 10/963,917 filed Oct. 12, 2004 in the name of the same inventor, Dean Christal, and entitled DIGITAL FILE CONSUMER GOOD PROMOTION METHOD AND VENDING MACHINE DEVICE, the entire disclosure of which is incorporated herein by this reference thereto.

### FIELD OF THE INVENTION

This invention relates generally to distribution and promotion methods and devices and specifically to a system providing enhanced downloads of digital files including games, data, books, music and video.

### STATEMENT REGARDING FEDERALLY FUNDED RESEARCH

This invention was not made under contract with an agency of the US Government, nor by any agency of the US Government.

### BACKGROUND OF THE INVENTION

It is now well known that audio, video and digital files may be downloaded from Internet based services to home computers and thereafter downloaded to small portable player devices. The presently most popular form of this is the MP3 player, however, video content and data content may be so downloaded as well.

Less well known is the race to develop a commercially successful vending machine allowing this process. However, work is on-going in this area and the following list of patents shows the great interest in this. Most such devices concentrate upon the fundamental transfer and pay relatively less attention to successful commercialization of the concept. In particular, as of the date of application there has not yet been a commercially successful effort to vend digital music or video, despite attempts dating back at least five years.

Patentability searching in the field yields a number of references.

US Patent Publication No. 2004/0086120 published May 6, 2004 in the name of Akins, III et al, teaches a satellite TV system for downloads and management thereof, and therefore teaches away from any vending related system of downloads.

US Patent Publication No. 2003/0061301 published Mar. 27^{th}, 2003 in the name of Chethik et al teaches a stereo system for downloads and management thereof, and therefore has the same problem that it teaches away from any vending related system of downloads.

US Patent Publication No. 2002/0069127 published Jun. 6, 2002 in the name of Enari teaches a method of acquiring file identification codes in order to speed purchases. The device teaches that a telephone may be used to acquire the codes prior to purchase at a store, thus teaching away from any vending machine or product placement.

US Patent Publication No. 2002/0042777 published Apr. 11, 2002 in the name of Yoshida et al teaches a method of providing credit in a recording medium.

U.S. Pat. No. 6,799,084 published Sep. 28, 2004 in the name of Grobler teaches a device for providing a CD or other known media format with music downloads or the like, and thus teaches away from use of a vending device or actual data player. It is also silent regarding methods of product promotion.

U.S. Pat. No. 6,779,115 published Aug. 17, 2004 in the name of Naim teaches use of a smart card for identity and credit determination of the user.

U.S. Pat. No. 6,711,464 published Mar. 23, 2004 in the name of Yap et al teaches a CD vending system and thus teaches away from use of MP3 players or product promotion methods.

U.S. Pat. No. 6,594,548 published Jul. 15, 2002 in the name of Bagnordi teaches use of PDAs, ebooks and smart cards to receive non-audio-video format works. It does not teach any methods of business development.

U.S. Pat. No. 6,567,847 published May 20, 2003 in the name of Inoue teaches a network system for allowing users to lay open their own works for public perusal. It does not as such deal with product placement nor promotion otherwise.

U.S. Pat. No. 6,535,791 published Mar. 18, 2003 in the name of Wang teaches a vending method directed towards printed materials, and thus teaches away from transfer of data files to the player of a user.

U.S. Pat. No. 6,507,727 published Jan. 14, 2003 in the name of Henrick teaches a method of identifying or securing music heard on broadcast radio stations.

U.S. Pat. No. 6,330,490 published Dec. 11, 2001 in the name of Kim et al teaches vending of traditional magnetic or optical devices of traditional CD or audio tape type, and does not deal with promotion of products.

U.S. Pat. No. 5,781,889 published Jul. 14, 1998 in the name of Martin et al teaches a method of managing a network of “jukebox” style music players, and thus teaches away from commercial downloads.

U.S. Pat. No. 5,768,142 published Jun. 16, 1998 in the name of Jacobs teaches towards “expert” or relational suggestion of choices of files to users based upon the users' past buying choices. It thus teaches away from product promotion driven by commercial considerations.

On-line copyright piracy has also been a significant problem. It would be preferable to provide users, especially young users, with a convenient, appealing and legal forum for file downloads.

US Patent Publication No. 2004/0193610 published Sep. 30, 2004 to Alex et al teaches a networked entertainment consol at a commercial establishment seating area. The device does not teach downloads.

US Patent Publication No. 2004/0159699 published Aug. 19, 2004 to Nelson et al teaches a point of sale station (POS station) which may use the Internet. It does not deal with downloads at all.

US Patent Publication No. 2004/0002359 published Jan. 1, 2004 to Deas et al teaches an automobile borne device for use with an “information filling station”.

US Patent Publication No. 2003/0191698 published Oct. 9, 2003 to Brown et al teaches using small portable computing devices as POS stations and interfacing with inventory control and the like.

US Patent Publication No. 2003/0004889 published Jan. 2, 2003 to Fiala et al teaches a product having a PIN number which is not accessible prior to sale of the product. However, this deals with packaging rather than downloads or access codes printed by a POS station.

US Patent Publication No. 2002/0194078 published Dec. 19, 2002 to Villaret et al teaches connection of a portable appliance such as a PDA or Bluetooth device directly to a POS station. The security disadvantages of such a system are manifest.

In the unrelated field of automated carwash services, it is known to print out a small receipt on which a customer may find an access code good for a carwash at the service station selling the service.

It would be preferable to provide a system by which retailers, restaurants, malls and commercial establishments in general may be used to provide digital file download services.

It would further be preferable to provide a system allowing such downloads without impacting the operations of the clerical personnel of the commercial establishment.

### SUMMARY OF THE INVENTION

General Summary

The present invention teaches a method and system for promoting digital file downloads by placing download terminals at commercial establishments which prepossess a high volume of customer traffic. For example, hamburger stands and other restaurants, coffee shops, clothing outlets, sporting goods outlets, malls, food courts, video parlors, movie theaters, book stores or any other type of commercial establishment may receive a download terminal.

The point-of-sale (POS) station (cash register) of the commercial establishment sells an access code which the user then enters via scanning or manual or electronic entry to the download terminal in order to receive a digital file download. Thus, the customer makes a transaction with the sales clerk in a traditional manner, in embodiments identifying the digital product desired and in other products not doing so. The sale is completed by any normal commercial process at the POS station. The access code provided may be provided electronically, however, in the presently preferred embodiment, the access code is printed on a small piece of paper such as the sales receipt. The sale may include price terms (such as a free giveaway of the digital file product, rendering it a “no cost” sale), sale terms, discounts, tie-ins, and the like.

The access code may identify the digital file to download, or the user may identify the file to download when the user reaches the download terminal. The user may identify the desired product using programable softbuttons present either on a video screen of the terminal or as reprogrammable hard buttons. The user may in embodiments have no choice of download, or source of the digital download, or may be offered a choice coming from a download library source within the terminal, or a remote library file source elsewhere, or may even have a choice of different sources.

The digital files downloaded may by MP3 files, ring tones, music files, video files, data files, programs, game files and combinations thereof.

The invention includes an output device allowing the user to attach a player to accept the downloaded file. The player may be an MP3 player, a video player, a PDA, a game player, a small computer, a telephone, camera, other consumer electronic devices, similar devices and combinations thereof.

Summary in Reference to claims

It is therefore a first aspect, advantage, embodiment and objective of the present invention to provide a method of promoting digital file downloads, the method comprising the steps of:
a) providing to a commercial establishment having pre-existing high customer traffic volume a download terminal located at the commercial establishment;
b) distributing an access code at a point of sale station at the commercial establishment;
c) inputting the access code at the download terminal; and
d) downloading a digital file.

It is therefore a second aspect, advantage, embodiment and objective of the present invention to provide a method of promoting digital file downloads, wherein the data file further comprises one member selected from the group consisting of: MP3 files, music files, video files, data files, book files, game files and combinations thereof.

It is therefore a third aspect, advantage, embodiment and objective of the present invention to provide a method of promoting digital file downloads, further comprising the step of:
e) providing video advertising on the terminal when not in use.

It is therefore a fourth aspect, advantage, embodiment and objective of the present invention to provide a method of promoting digital file downloads, wherein the access code further identifies the digital file to be downloaded.

It is therefore a fifth aspect, advantage, embodiment and objective of the present invention to provide a method of promoting digital file downloads wherein the terminal further comprises at least one softbutton identifying the source of the digital file to download, and further comprising the step of:
c1) selecting the digital file to download.

It is therefore another aspect, advantage, embodiment and objective of the present invention to provide a method of promoting digital file downloads, wherein the distribution of the access code further comprises a sale.

It is therefore another aspect, advantage, embodiment and objective of the present invention to provide a method of promoting digital file downloads, (ditto)

It is therefore another aspect, advantage, embodiment and objective of the present invention to provide a digital file download system allowing a commercial establishment to promote digital file downloads, the download system comprising:
a) a data output device;
b) a code input keypad;
c) a download management module allowing download of at least one digital file to the data output device upon entry of a code at the code input keypad.

It is therefore another aspect, advantage, embodiment and objective of the present invention to provide a digital file download system wherein the data output device is a standard port.

It is therefore another aspect, advantage, embodiment and objective of the present invention to provide a digital file download system wherein the data output device is a standard MP3 player interface.

It is therefore another aspect, advantage, embodiment and objective of the present invention to provide a digital file download system wherein the data output device is one member selected from the group consisting of: an RS232, a parallel port, a USB port, an IEEE 1394 port, a standard audio jack port, a stereo minijack port, an RJ-45 port, an RJ-11 port, a BLUETOOTH device, another wireless connection, and combinations thereof.

It is therefore another aspect, advantage, embodiment and objective of the present invention to provide a digital file download system further comprising:
d) a programmable softbutton allowing selection of at least one desired digital file.

It is therefore another aspect, advantage, embodiment and objective of the present invention to provide a digital file download system further comprising:
e) a point-of-sale station having a module able to generate the access code.

It is therefore another aspect, advantage, embodiment and objective of the present invention to provide a digital file download system further comprising:
f) an operative electronic connection to an external source of the digital file.

It is therefore another aspect, advantage, embodiment and objective of the present invention to provide a digital file download system further comprising:
g) an operative electronic connection to a terminal control unit having a module able to remotely alter the operation of the terminal.

It is therefore another aspect, advantage, embodiment and objective of the present invention to provide a digital file download system further comprising:
h) a touch sensitive video screen, wherein the keypad is implemented on the video screen.

### BRIEF DESCRIPTION OF THE DRAWINGS

FIG. 1 is a front view of a download terminal according to the invention.

FIG. 2 is a schematic front view of a commercial establishment according to the invention.

FIG. 3 is a schematic view of a network according to one alternative embodiment of the invention.

FIG. 4 is a schematic view of a network according to a second alternative embodiment of the invention.

FIG. 5 is a flow chart of the method of the invention.

FIG. 6 is a front view of a download terminal according to another alternative embodiment of the invention.

### INDEX TO THE REFERENCE NUMERALS

Download terminal 102
Video screen 104
Output device 106
Keypad 108
Video softbutton 110
Hardware softbutton 112
Download management module 114
Commercial establishment 202
POS station 204
Wall 206
Download terminal 208
Vending network management unit 302
Networked download terminal 304, 306
Operative electronic connection 308a, 308c
Digital file source 310
POS station 312
Operative electronic connection 314
Operative electronic connection 316
Commercial establishment 318
Vending network 402
Networked download terminal 404, 406
Operative electronic connection 408a, 408c
POS station 412
Operative electronic connection 414
Operative electronic connection 416
Commercial establishment 418
Download terminal 602
Video screen 604
Output device 606
Code Scanner 608
Video softbutton 610
Hardware softbutton 612
Download management module 614
Provide commercial establishment 1000
Provide access to terminal 1002
Sell access code at POS 1004
Input access code at terminal 1006
Download digital file 1008

### DETAILED DESCRIPTION

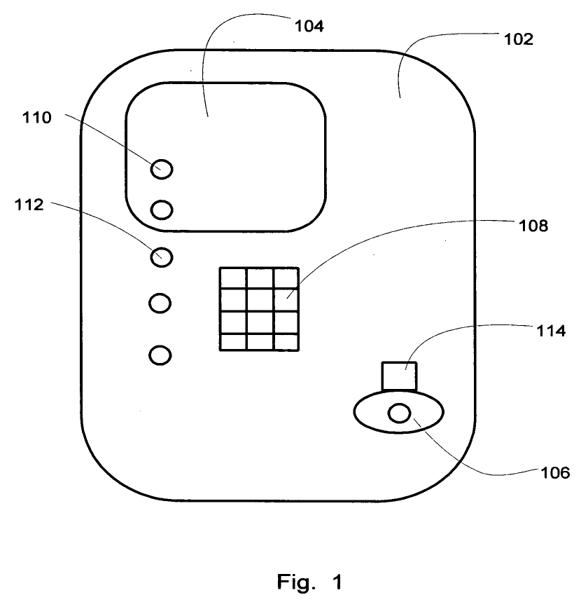

FIG. 1 is a front view of a download terminal according to the invention. This terminal may be independent of any network connection.

Download terminal 102 may be a small device large enough to allow easy human input but small enough to be easily mounted on a counter top or wall or other out of the way location. It may in embodiments be free standing.

Video screen 104 may be used to allow users to identify their choice of digital file or source of digital file. It may also be used for advertising purposes, particularly in embodiments in which the video screen is extremely large or covers one entire side of the machine. Video screen 104 may be touch sensitive, as noted two paragraphs below in reference to softbuttons. Video screen 104 may incorporate a speaker to allow audio output, this is useful for adding impact to advertising.

Output device 106 may be a standard port such as is used to establish an operative date connection to the data player which is hooked up to the output device 106 when the download is carried out. This may be a physical data connection, a wireless data connection or the like. Various protocols for wireless applications (for example BLUETOOTH™) may be used, and similar protocols for wired applications as well. The data output device is normally primarily used for output, however, it may be used for input operations as well, such as reading the identity of a data player attached to it. Note that there may be more than one output device 106, or output device 106 may be able to connect to more than one data player simultaneously. As an example, a BLUETOOTH™ device may well be able to download to five different data players simultaneously. Examples of output device 106 include an RS232, a parallel port, a USB port, an IEEE 1394 port, a standard audio jack port, a stereo minijack port, an RJ-45 port, an RJ-11 port, a BLUETOOTH device, another wireless connection and combinations thereof, but include other such data connections now known or later developed.

Keypad 108 may advantageously be a very simplified keypad of low cost and small size, for example a standard 12 key pad having the numerals 0 through 9, an asterisk key and a pound sign key. Smaller selections of keys allow a smaller overall terminal and reduce cost. As few as five keys may easily be used to provide access codes which give substantial security. Larger keypads, even keyboards having 100 or more keys, may advantageously be used in embodiments in which functions in addition to mere entry of the access code are contemplated.

In one alternative embodiment, the keypad may be eliminated and the softbuttons may be used in place of that. For example, five softbuttons allow secure access codes, and being softbuttons, could be programmed to switch after code entry to have an entirely different function as detailed in the next paragraph. A keypad or keyboard may also be implemented on the touch sensitive screen embodiments, thus eliminating the need for any keypad whatsoever.

Download management module 114 comprises modules controlling operation of the terminal, specifically controllers for output device 106, modules able to receive the access code and verify that it is correct, modules to carry out secondary advertising functions of the terminal and other control tasks as needed.

Download management module 114 may further comprise a mass storage device for digital data which allows the terminal to maintain a digital file ready for download by users. In embodiments, download management module 114 may allow storage of more than one selection of digital file, and modules allowing user selection of the desired module, for example by means of video softbutton 110 and/or hardware softbutton 112.

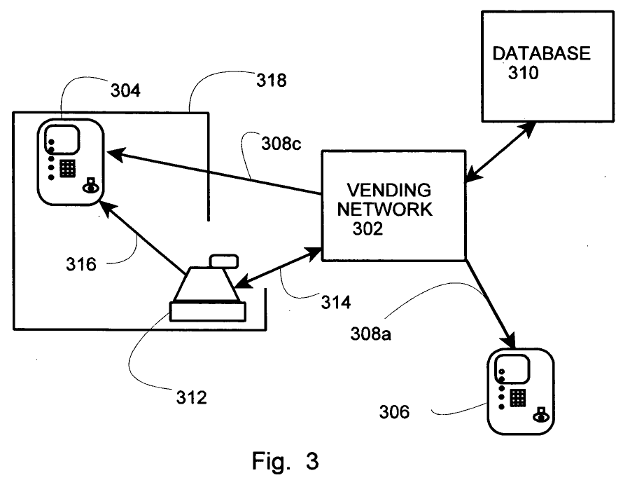

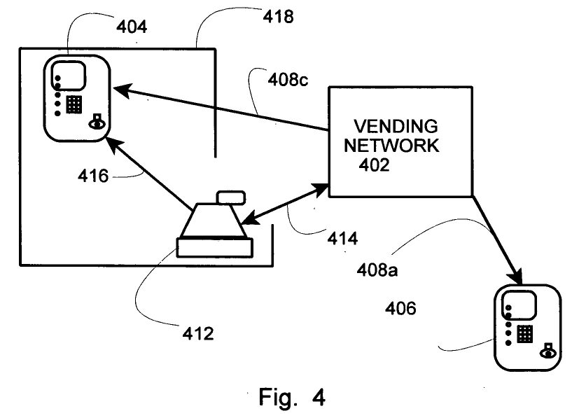

Softbuttons 110, 112 may be used to provide easier access to the digital files to be downloaded. For example, a video game (for which the commercial establishment having the terminal may also have exclusive rights of distribution) may be assigned a softbutton for a period of time so that the increased volume of users desiring that product may download it into game players with relative ease. A popular music file in MP3 or another common format may be assigned a softbutton to provide easy access to that particular popular file. Entire libraries owned by companies which compile and maintain databases of digital files may be assigned to a button, or other commercial or data structures may be. The advantage of a softbutton in this area is that by definition, a softbutton is one that is easily reprogrammable rather than assigned a fixed value unlike the digits on the access code keypad. This allows swift reprogramming in response to changes in the commercial situation. Such reprogramming may occur on-site at each machine or in embodiments the machines may be reprogrammed remotely. Such remote reprogramming may occur (in the embodiments discussed in reference to FIGS. 3 and 4) via a download network unit, or at the POS, or via a network or dial-up connection unrelated to the download function of the terminal, such as a network dedicated to the reprogramming function only.

One purpose of the invention is to track royalty rights of performers, artists, programmers, writers and other intellectual property owners. In general, by use of the access code system, theft of songs, videos, movies, games, books and other digital files may be prevented. In addition, the system allows easy tracking (in the download management module or the network management unit of networked embodiments) of royalties owed and parties the royalties are owed to. Another purpose of the invention is to avoid the necessity of allowing users to hook electronic appliances to the POS stations of commercial establishments, a security prospect unappetizing to the typical retailer.

It will be appreciated that numerous marketing stratagems are possible in the method of the invention. For example, a popular singer may have a new song to be promoted. A commercial establishment may use the royalty control and file download capabilities of the invention to “lock up” rights, thus becoming the only purveyor of a potentially very popular song. In another embodiment, a highly touted game may be offered exclusively through the franchise or chain of the commercial establishment. Such rights may be exclusive, non-exclusive, time limited, may require payment of a single large fee for unlimited download rights, may require payment per download, and so on. In addition, such downloads may be then tied into the products of the commercial establishment. For example, the commercial establishment may offer a deal such as “Buy an ecstatic meal, get a free download from the band X2C!” The products may also be reverse marketed: “Buy a download, get a free pair of Air River socks!”. In addition, these techniques allow tie in to actual player sales, in which the user gets free downloads or the goods of the commercial establishment on a discounted or free basis due to having bought a player.

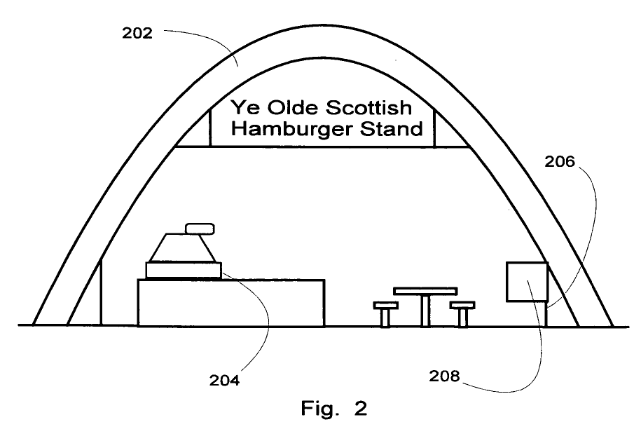

Thus, FIG. 2 is a schematic front view of a commercial establishment according to the invention. Commercial establishment 202 is depicted as a fast food restaurant, but it may be any type of commercial institution in which a high volume of customer traffic may be expected, such as hamburger stands and other restaurants, coffee shops, clothing outlets, sporting goods outlets, malls, food courts, video parlors, movie theaters, book stores or any other type of commercial establishment may receive a download terminal.

POS station 204, walls, tables, display areas, counter tops, pillars, furniture and so on are normal parts of such establishments. Wall 206 may have thereon download terminal 208 according to the present invention, but the other structure listed may of course receive the download terminal instead.

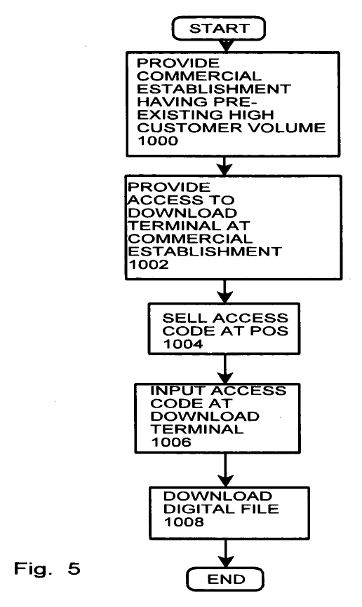

FIG. 5 is a flow chart of the method of the invention, as might be carried out at such an institution. The first step is to provide a commercial institution having high customer traffic, this “provision” may be by creation of such an operation or merely by selection of a retail establishment, entering into an agreement with such an operation or so on, all of which and equivalents being subsumed within step 1000, “Provide commercial establishment”.

Provide access to terminal 1002 may consist of placing the terminal on a public wall (as shown in FIG. 2) or it may be otherwise be made publically accessible to the customers of the establishment.

Sell access code at POS 1004 teaches that the access code may be sold by the clerical staff of the establishment as part of another sale (“Buy a hamburger, get a download for 25 cents”), by itself (“Any download, just 49 cents!”), in quantity, as a free giveaway or other free inducement, and so on. In any case, the customer indicates that they wish to buy a download, and depending upon the embodiment of the invention, either identifies the desired content to the sales person or does not. The sales clerk rings up the sale in the usual manner, using the devices and subsystems of the POS station.

In alternative embodiments, the POS station may then immediately transmit the “identity” of the access code to the download terminal. In other embodiments, the access codes may be provided to the POS station by the download terminal, or may be provided to both by a third unit. A number of access codes may be active in the download terminal, and the POS station may simply select from that list when providing on the customer.

In one embodiment, a small machine “behind the counter” provides the access code (either numeric or bar code or electronic or otherwise) at the push of a button. The machine is controlled by the clerks at the POS station, who when selling a download or giving one away for free as part of a promotion, or whenever a download is authorized, simply use the small access code providing machine at/near the POS station to print out or electronically encode the access code.

It is also possible to electronically encode the access code. For example, the access code may be encoded into the actual player of the user (into an MP3 player, a video player, a game player, etc) or may simply provide download credit based upon the unique address of the player. The user then hooks up the player to the output device 106 and the download management module verifies the credit or identity of the player hooked up.

The access code may be printed out on the customer's receipt, or it may be printed out by the POS station on another slip of paper. It may also be placed into an electronic device by the POS station, though this embodiment may be complex and less secure.

Input access code at terminal 1006 is the step of the user punching the access code into the keypad and being informed that it has been accepted by the terminal and that they may begin a download.

In embodiments, the access code input may be time limited. In one embodiment, this time limit may allow the code to be used until a certain time has passed, thus requiring users to make use of the download within a period of time. However, in another embodiment, the access code may be used after a certain time has passed, thus requiring the user to come back to the commercial establishment on a later date. In addition, both techniques may be used for the same access code.

Download digital file 1008 may include a number of other steps, such as selection of the digital file, selection of the source of the digital file, viewing advertisements, answering brief marketing surveys and the like. The customer will also establish an operative connection between their player device and the output device. This may be an electronic connection, a wireless connection and so on. The download management module 114 will handle the “electronic housekeeping” aspects of the download, in a manner known to those skilled in the art.

FIG. 3 is a schematic view of a network according to one alternative embodiment of the invention. Vending network management unit 302 and the embodiment of a “networked” download terminals 304, 306 have operative electronic connections 308a, 308c. Digital file source 310 is illustrated to show that it may be external to both the vending management unit 302 and to the terminals 304, 306. The desired digital file source 310 may be a library of electronic products such as games, music files, image/video files, data files, books and so on.

POS station 312 may also be networked and various operative electronic connection 314, 316 show that the POS station may communicate with the terminal installed in commercial establishment 318 (for example for marketing purposes or to transfer access codes).

FIG. 4 is a schematic view of a network according to a second alternative embodiment of the invention. Vending network 402 and networked download terminals 404, 406 once again have operative electronic connections 408a, 408c between them POS station 412; operative electronic connections 414, 416 and commercial establishment 418 are much as described in other embodiments. In this embodiment, the source of the digital files is within the overall network, either centralized (for example, at vending network 402 or one of the machines of the network) or is distributed, perhaps a subset of the sum total of the files being present on each machine in the network, with additional RAID type back-ups within the system to allow recovery of any files from any crashed or damaged mass storage in an individual machine.

Note that in the embodiments of FIGS. 3 and 4, it is possible for the POS station to send the access code directly to the download terminal.

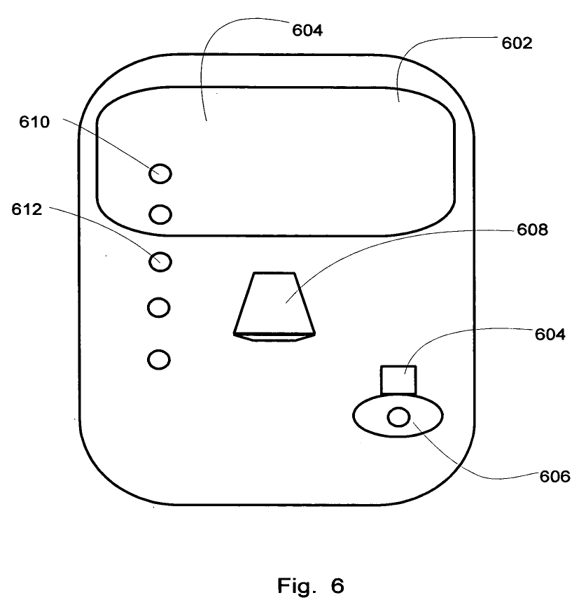

FIG. 6 is a front view of a download terminal according to another alternative embodiment of the invention. Download terminal 602, much like embodiments previously described, has video screen 604 having a speaker mounted therein. Terminal 602 also has output device 606, code scanner 608, video softbutton 610, hardware softbutton 612 and download management module 614. Unlike the first embodiment shown in FIG. 1, this embodiment uses a standard scanner to read access codes printed in machine readable format, which is the preferred embodiment and best mode now contemplated. There are numerous such formats, such as bar codes, machine readable numerals, and the pseudo-random patterns used in modern postage metering schemes. All such formats now known or later developed may be used to print and scan the access code.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of promoting digital file downloads, the method comprising the steps of:
a) providing to a commercial establishment having pre-existing high customer traffic volume a download terminal located at the commercial establishment;
b) distributing an access code at a point of sale station at the commercial establishment;
c) inputting the access code at the download terminal; and
d) downloading a digital file.

2. The method of claim 1, wherein the data file further comprises one member selected from the group consisting of: MP3 files, music files, video files, data files, book files, game files and combinations thereof.

3. The method of claim 1, further comprising the step of:
e) providing video advertising on the terminal when not in use.

4. The method of claim 1, wherein the access code further identifies the digital file to be downloaded.

5. The method of claim 1, wherein the terminal further comprises at least one softbutton identifying the source of the digital file to download, and further comprising the step of:
c1) selecting the digital file to download.

6. The method of claim 1, wherein the distribution of the access code further comprises a sale.

7. The method of claim 1, wherein the inputting the access code at the download terminal further comprises one member selected from the group consisting of: scanning in a machine code, reading an electronic code, punching in a code manually on a keypad, and combinations thereof.

8. A digital file download system allowing a commercial establishment to promote digital file downloads, the download system comprising:
a) a data output device;
b) a code input keypad;
c) a download management module allowing download of at least one digital file to the data output device upon entry of a code at the code input keypad.

9. The download system of claim 8, wherein the data output device is a standard port.

10. The download system of claim 9, wherein the data output device is a standard MP3 player interface.

11. The download system of claim 10, wherein the data output device is one member selected from the group consisting of: an RS232, a parallel port, a USB port, an IEEE 1394 port, a standard audio jack port, a stereo minijack port, an RJ-45 port, an RJ-11 port, a BLUETOOTH device, another wireless connection, and combinations thereof.

12. The download system of claim 11, further comprising:
d) a programmable softbutton allowing selection of at least one desired digital file.

13. The download system of claim 8, further comprising:
e) a point-of-sale station having a module able to generate the access code.

14. The download system of claim 8, further comprising:
f) an operative electronic connection to an external source of the digital file.

15. The download system of claim 8, further comprising:
g) an operative electronic connection to a terminal control unit having a module able to remotely alter the operation of the terminal.

16. The download system of claim 8, further comprising:
h) a touch sensitive video screen, wherein the keypad is implemented on the video screen.

17. A digital file download system allowing a commercial establishment to promote digital file downloads, the download system comprising:
a) a data output device;
b) a code input scanner;
c) a download management module allowing download of at least one digital file to the data output device upon entry of a code at the code input scanner.

18. The download system of claim 17, further comprising:
d) a module able to generate the access code.

19. The method of claim 1, further comprising the following step:
d1) receiving the digital file into a player, the player being one member selected from the group consisting of: an MP3 player, a video player, a PDA, a game player, a small computer, a telephone, a camera, and combinations thereof.

20. The download system of claim 8, further comprising:
d) a player attached to the data output device, the player electronically connected so as to receive the digital file, the player being one member selected from the group consisting of: an MP3 player, a video player, a PDA, a game player, a small computer, a telephone, a camera, and combinations thereof.
